(19) United States
(12) Patent Application Publication
(10) Pub. No.: US 2009/0249986 A1
(43) Pub. Date: Oct. 8, 2009

(54) Encasement of furnishings with magnetic forces

(76) Inventors: Lane S. Joanis, Brighton, MI (US); Brandon Muscott, Midland, MI (US)

Correspondence Address: Currie Kendall PLC, 6024 Eastman Ave, Midland, MI, 48640-2518, US

(21) Appl. No.: 12/384,055

(22) Filed: Mar. 31, 2009

Related U.S. Application Data
(60) Provisional application No. 61/072,719, filed on Apr. 2, 2008.

(51) Int. Cl. E05G 1/024; B32B 1/08; E05G 1/026

(52) U.S. Cl. 109/24; 428/34.1

(57) ABSTRACT

Disclosed is a kit and method for encasing an object such as a gun safe made out of a magnetic attracting material such as ferrous metal. The disclosed invention provides for the adhesion of heavy materials such as wood panels and related components to provide an ascetic appearance of fine furniture through the use of magnetic forces providing a solid and simple assembly allowing any user to improve the appearance of an existing object, such as a gun safe.

### CROSS REFERENCES TO RELATED APPLICATION

This application claims the benefit of the filing date of U.S. Provisional Application No. 61/072,719 filed Apr. 2, 2008.

### FIELD OF THE INVENTION

Described here are kits, devices, methods and processes for enclosing i.e., covering the surface of box shaped objects such as safes, cabinets, appliances and other objects that have magnetic attracting properties for aesthetic purposes. In particular, the description relates to an assembly kit that can be easily installed by the user onto a variety of items such as, for example, gun safes, and other safes used to protect valuables.

### BACKGROUND

The prior art reflects many various devices, methods and processes for adhering various items to walls, ceiling, floors, and appliances. The art, however, reveals that the primary use has been small magnetic items such as refrigerator magnets, or specific methods to apply other light weight items such as tiles. None have disclosed the use of magnetic forces to attach heavier weight items such as, for example, wood panels. The present invention discloses devices, methods, and processes that allow for the attachment of these heavier weight items to objects such as a metal gun safe. For example in U.S. Pat. No. 7,075,085, a magnetic decorative cover is disclosed for metal office furniture consisting of a magnetic sheet to which is adhered a decorative cover. The decorative cover appears to be composed of relatively light materials such cloth, leather, wood veneers and the like and do not include any molding or the like that gives the object the appearance of fine furniture.

The invention allows for the adhesion of heavier panels and related components, made from, for example, wood panels, to encase or enclose magnetically compatible materials such as ferrous metals. Through a combination of the embedding of magnets into a wood panel such magnets having sufficient magnetic power to firmly adhere heavy panels and related components so as to provide precise placement of the panels components without risk of unintentional slippage due to contact.

### BRIEF SUMMARY OF THE INVENTION

Broadly, described here are kits, devices, methods, processes for enclosing, covering the surface of, metal objects such as safes, cabinets, appliances and other objects that have magnetic attracting properties for aesthetic purposes and the furniture made therefrom. Generally, the preferred embodiment described here comprises an assembly comprised of various panels and related components that utilize embedded magnets of sufficient magnetic force for adhesion of heavy panels or related components to a gun safe or other safe or cabinet that are made of magnetic attracting materials such as ferrous metals.

Any combination of panels, molding, fluted wood columns, tiles or other related components might be utilized in the assembly of the invention to achieve the desired result. One embodiment might utilize two or more panels for enclosing the front and sides of an object such as a gun safe. In one variation panels incorporating the invention might be used to cover a metal garage door. In another embodiment there are also included corner moldings that are affixed to the panels and/or include magnets to give the object, such as a gun safe a look of fine furniture.

### DESCRIPTION OF THE DRAWINGS

Embodiments or variations are now described by way of example with reference to the accompanying drawings. Objects, features, and advantages of inventive matter disclosed herein may be better understood by referring to the following description in conjunction with the drawings, in which the numerals indicate like structural elements and features in the various figures. The drawings are not meant to limit the scope of the invention. For clarity, not every element may be labeled in every figure. The drawings are not necessarily to scale, emphasis instead being placed upon illustrating the principles of the invention.

FIG. 1 shows a completed assembly of a preferred embodiment of the inventive features of the invention described herein.

FIG. 2 shows an un-enclosed gun safe having a front door that fits flush with the front surface of the safe leaving a portion of the front edge surrounding the door exposed.

FIG. 3 shows a gun safe and various panels and related components in an exploded view before assembly.

FIG. 4 shows a metal gun safe and the back of various panels and related components before being assembled indicating an embodiment of the location of the magnets used to attach the panels to the gun safe.

FIG. 5 shows a garage door.

FIG. 6 shows an assembly of panels secured to the face of the garage door.

FIG. 7 shows an embodiment of slotting and hooks connections for assisting in connecting front and side panels.

### DETAILED DESCRIPTION

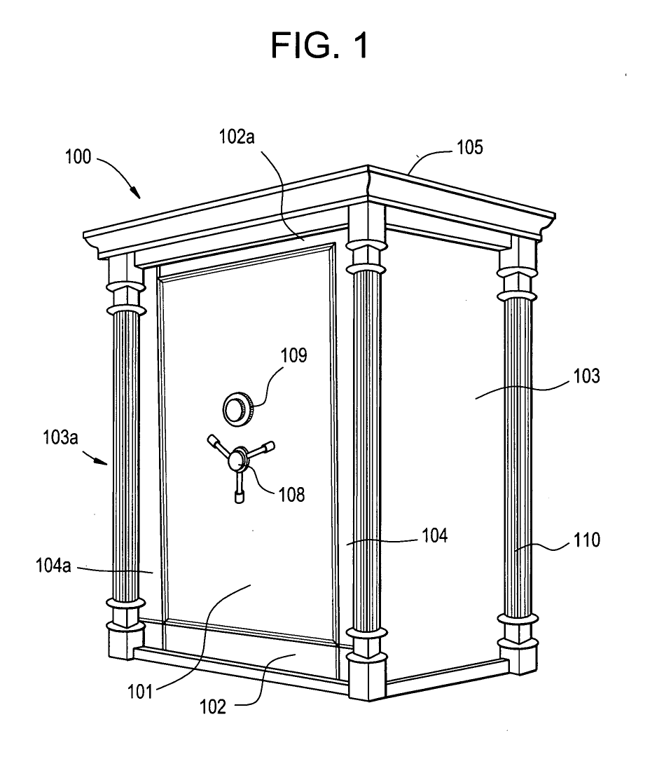

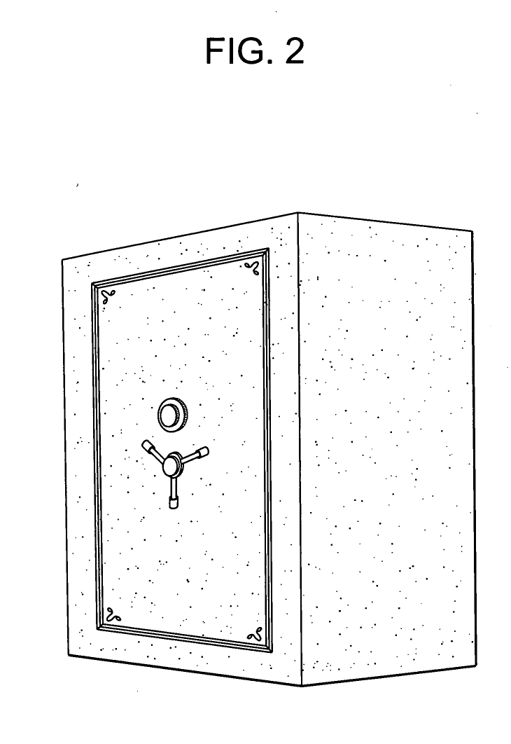

FIG. 1 shows a completed assembly 100 of a preferred embodiment of the disclosed invention. The front panel 101 and side panels 103 and 103a are attached to the receiving object such as for example a gun safe as depicted in FIG. 2. In the embodiment of FIG. 1 the decorative top 105 of the assembly 100 slides down overlapping onto the front 101 and side 103 and 103a panels to provide a decorative top while providing additional securing of the front and side panels. The area of the front of the safe between the edge of the flush fitting door and the corners of the front of the safe are also covered with panels 102, 102a and 104 and 104a.

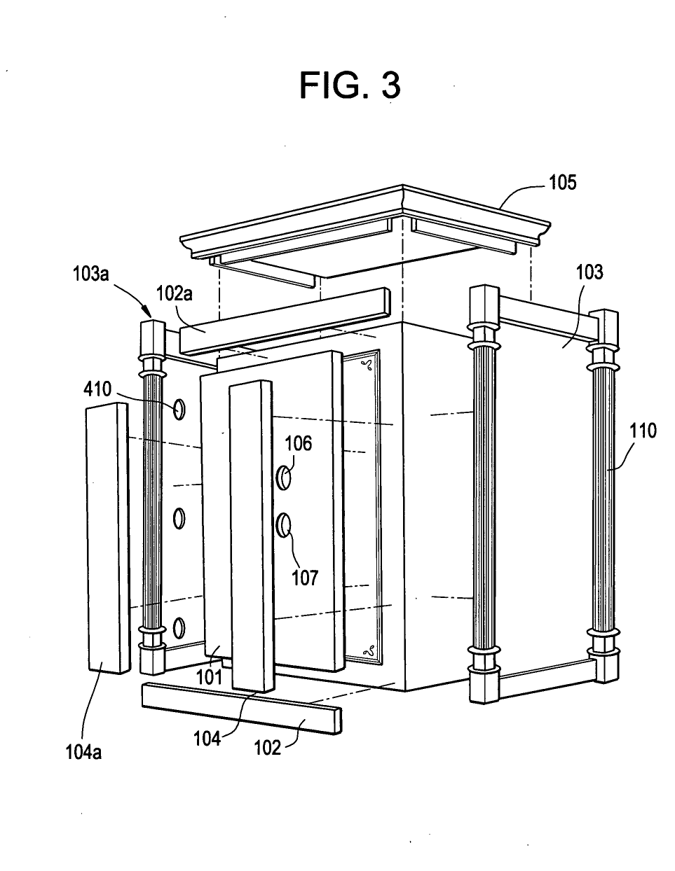

FIG. 3 shows the various panels and related components that comprise the assembly 100 of the invention in an exploded view prior to assembly.

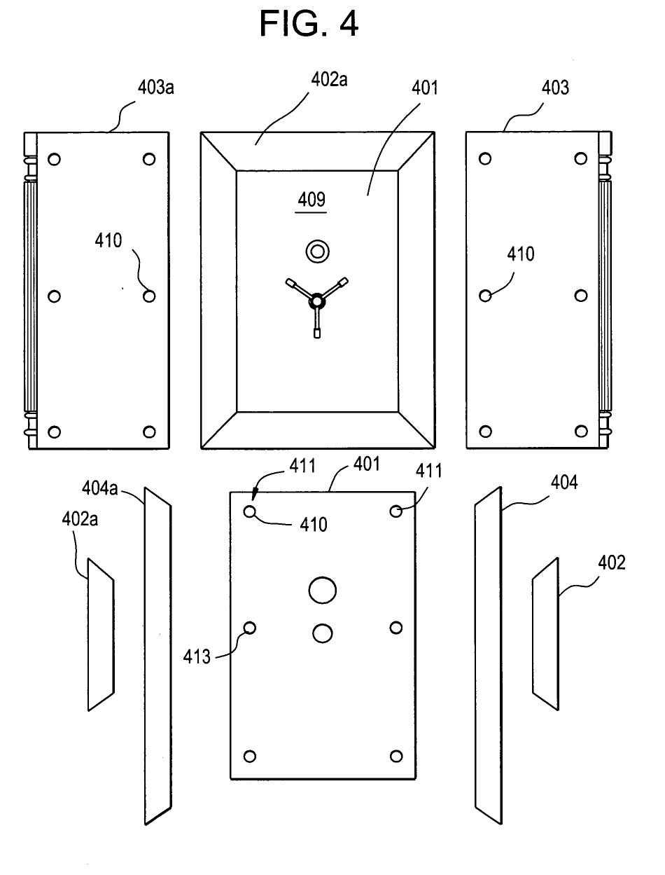

FIG. 4 depicts the back sides of the front panel 401, side panels 403, 403a and related components 402, 402a, 404, 404a (these comprise for example additional strips of paneling that fit around the edge of the front of the gun safe between the top and side edges and the door of the safe that might be included for decorative and covering purposes on the front of the object to be encased, such as a gun safe 409. Location of magnets is indicated by numbers 410, 411 and 413.

In the preferred embodiment the panels might be made of fine, but heavy hard wood such as maple or veneers of the same. Magnets of sufficient strength to support the necessary weight to achieve secure and non-slidable adhesion to the gun safe are selectively located in several locations on the side of the panel that fits against the box shaped object such as a filing cabinet or gun safe. In the front panel 401 there might be embedded magnets 410 in the corners 411 and the middle of the side 413. The magnets are preferably reset into the panel and securely fastened with an adhesive. In this manner the panels lie flat against the box shaped object to be decorated. For the decorative strips 402 and 404 the magnet force might be achieved with strips of magnetic material rather than embedded magnets. Any magnetic force might be utilized however that could achieve the desired function of secure and non-slidable adhesion of the desired components.

While the preferred embodiment panels and related components are made of wood any material might be utilized that could encase a desired metal box shaped object such as a cabinet, desk, table, but preferably a safe such as a gun safe.

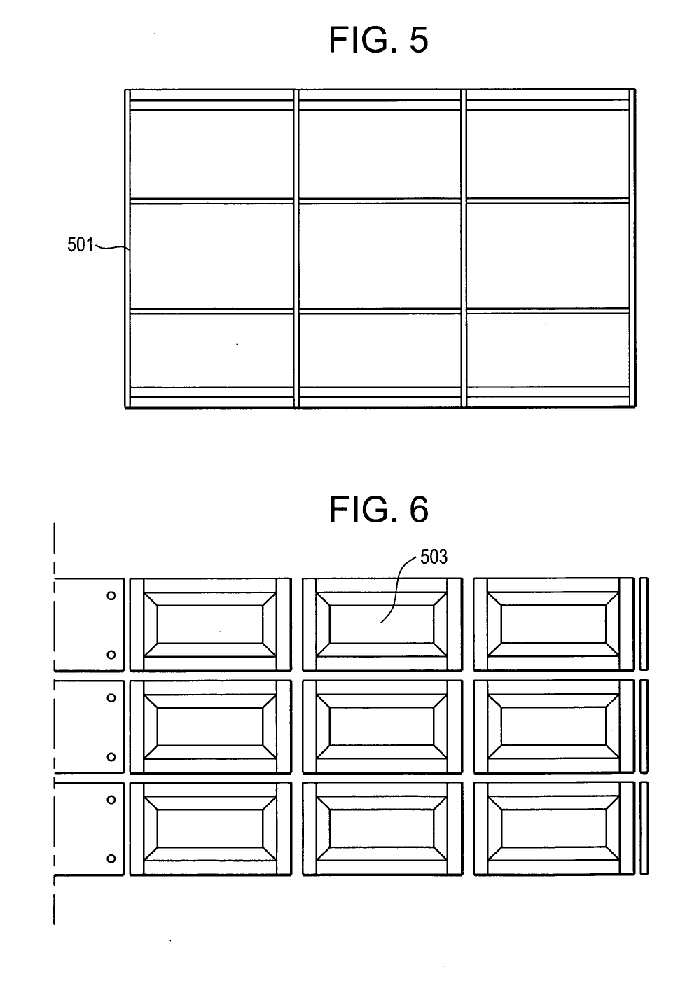

While the preferred embodiment disclosed a storage cabinet or safe such as a gun safe or any other box shaped object any object made from magnetic attracting material could be covered by the disclosed invention. For example, various heavy materials might be utilized with the method and processes of the disclosed invention, such as a garage door 501 shown in FIG. 5. As shown in FIG. 6 various panels 503 are arranged in a desired order and attached to the door 501 with the magnetic forces achieved with embedded magnets attached to the back of the panels similarly to those depicted in FIG. 4. By utilizing the disclosed methods herein square or rectangle panels 503 almost any material regardless of weight could be utilized to be attached to the door to give the door a different desired prospective.

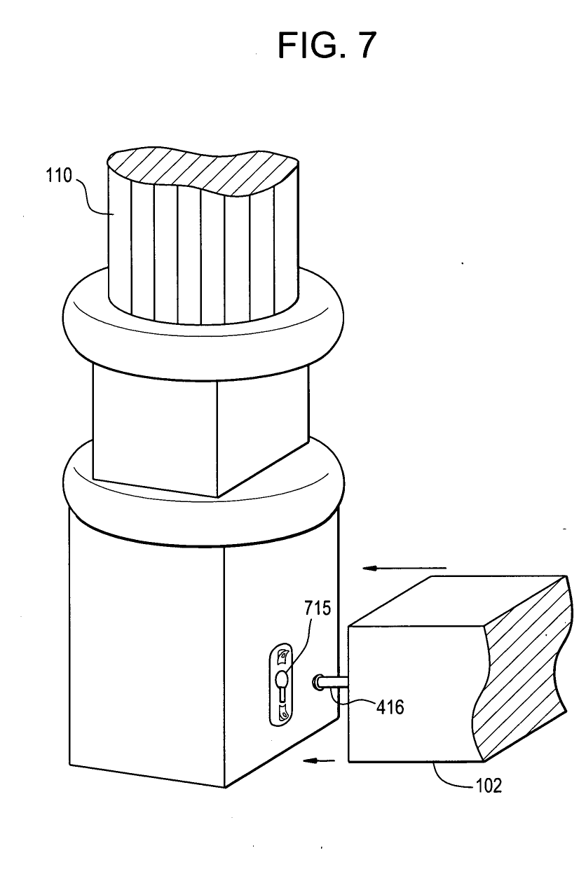

In one variation, depicted partially in FIG. 7 the front panel 102 and side panel 103 containing column 110 is further secured by providing “T” slotting 715 in the lower end of the column portion 110 of the side panel that receives the head of a bolt, screw or other hooking device 716 secured into the lower front panel 102 to secure the connection between the front and side panels further preventing accidental slippage of the panels.

Referring to FIG. 3 an example of the method and process for putting the assembly 100 together encasing a desired object such as a gun case is described. Half inch thick, ultra light fiberboard panels are cut to correspond with the outside dimensions of a safe to be covered. The panels are drilled in locations along the perimeter with a three inch Forstner bit three eights of an inch deep. Round flat Neodemyiam magnets are then glued into each of the holes leaving one eighth of an inch exposed above the surface of the fiberboard. Two part epoxy glue is used. Two side panels 103 and 103a and the panel for the door 101 were prepared in this manner. The crowned head top portion 105 is prepared and slides over the side panels and top front panel 102a. It relies on gravity to keep it in position. The door panel is drilled to provide two holes, 107 and 108 which permits access to the handle and lock 108 and 109 of the door to permit it to fit over them. The door and the two side panels are then coated with a common contact cement and hardwood veneer is applied to the sides opposite to the magnets and trimmed to a precision fit. Decorative hardwood trims and moldings such as fluted columns 110. Crowns such as shown for the top 105 and bases are added to enhance the style of the panels. They can be pre-made or specially prepared and are fastened to the panels using common methods such as glue, nails screws and the like. When completely assembled each of the panels are applied to the safe to ensure a good fit. They are then finished, for example, by applying an application of nitro cellulose sanding sealer followed by two coats of nitro cellulose lacquer. After drying, the panels and parts are refit to the safe to assure proper fit and then can be packaged in protective packaging as a kit for shipment to an ultimate user with instructions and how to assemble the kit onto identified safes. They can also be fitted to a safe and the safe sold or used a final product. If the safe includes a door which is smaller than the front of the safe vertical and horizontal wood strips 102, 102a and 104 and 104a are prepared in the same manner as the door and side panels and can be placed on the front of the safe.

In one variation additional smaller files such as wood files might be added to encase the opening mechanisms further enhancing the aesthetic appearance as well as concealing the obviousness that it is a safe. In another variation further decorative panels might also be added to the assembly. These panels or files could easily be removed and replaced with other files. Theses tiles might be removably rotated for example, based on the seasons, holidays or any other desire the user might have.

While the above description depicts the assembly of one preferred embodiment any variation or embodiment might be utilized. For example while preferred variations would encase an object such as furnishing, appliances or a door such as a garage door which are made of a magnetic attracting material such as a ferrous metal, any material might be encased by adding of attaching metal strips to the desired object. For example, in one variation, magnetic attractive materials such as ferrous metal might be adhered to desired locations on a wood cabinet which could then be encased by the assembly of the disclosed invention. Any material could be encased.

It will be appreciated by persons skilled in the art that numerous variations and/or modifications may be made to the described device as specifically shown here without departing from the spirit or scope of that broader disclosure. The various examples are, therefore, to be considered in all respects as illustrative and not restrictive.

What is claimed is:

1. A decorative kit for a box shaped object having attraction for magnetic forces, such as a metal gun safe having a least a substantially flat front and at least 2 substantially flat sides, said front and said sides having predetermined height, width and depth dimensions that are to be decorated, comprising:
A. a wood panel having substantially the same height and width dimensions as said front wherein side wood panel having a front and a back side and securely affixed to said back side a sufficient number of magnets of sufficient strength to mount said panel securely to said flat front of said metal box shaped object,
B. a second wood panel having substantially the same height and depth dimensions as the first side wherein said second wood panel has a front and a back side and securely affixed on said back side a sufficient number of magnets of sufficient strength to mount said second panel securely to said first side, and
C. a third wood panel having substantially the same height and depth dimensions as the second side said third wood panel having a front and back side and securely affixed to said back side a sufficient number of magnets of sufficient strength to mount said third wood panel securely to said second side.

2. The decorative kit of claim 1 including in addition a decorative wood top component which has a top and sides that are slightly greater in dimension than the dimensions of the top including he front and side panels that fits over said flat front and sides when said front and sides are attached to the box shaped object to thereby aid in securing the front and side panels to the box shaped object.

3. The decorative kit of claim 1 wherein said box shaped object is a safe having a from hinged door that fits flush with the front of said object and has dimensions less that are less than the width and height of the front of said object and thus providing exposed portions of the front around the door and said kit includes strips that cover said exposed front of said object and said door thereof that include magnets.

4. The decorative kit of claim 3 wherein said box shaped object is a safe.

5. The decorative kit of claim 4 wherein said safe is a gun safe.

6. A ferrous metal safe comprising:
A. a ferrous metal safe comprising a box shape defining a front said front also having as part thereof a door that fits flush with the surface of said front when closed, said safe also having two sides, a top, bottom and a back, each of said front, sides, top, bottom, back and door having predetermined dimensions,
B. at least three least wood panels having distinct shaped magnets attached to the inner surface thereof in a sufficient number and sufficient strength to adhere the panels to the door front and two sides of said safe said wood panels having substantially the same dimensions as said door, and said sides of the safe, and
C. a wood decorative top portion that fits on said top and snugly overlapping a portion of said wood panels adhered on the two sides.

7. The metal safe of claim 6 wherein said door has a dimension that is less than said front such that when said door is in the closed position there exists strips of metal between the outside edges of said door and said outside dimensions of said front and attached to said exposed strips of metal, wood strips having magnetic attraction to said exposed strips of metal, and said door has a wood panel having distinct magnets affixed thereto on the inner side that affixes said wood panel to said door.

8. The metal safe of claim 7 wherein said door defines at least one handle and the wood panel has a cutout that permits access to said handle.
